(19) United States
(12) Patent Application Publication
(10) Pub. No.: US 2009/0083561 A1
(43) Pub. Date: Mar. 26, 2009

(54) Dynamic power management of dimms

(76) Inventors: Nikos Kaburlasos, Rancho Cordova, CA (US); Jim Kardach, Saratoga, CA (US)

Correspondence Address: Caven & Aghevli LLC;c/o CPA Global, P.O. BOX 52050, MINNEAPOLIS, MN, 55402, US

(21) Appl. No.: 11/904,101

(22) Filed: Sep. 26, 2007

(51) Int. Cl. G06F 1/32

(52) U.S. Cl. 713/323

(57) ABSTRACT

In some embodiments, an electronic apparatus comprises a processor, at least one non-volatile memory module, and logic to activate a first DIMM while placing at least a second DIMM in a sleep mode, assign operating system memory to grow from a first location in a first DIMM device, assign application memory to grow from a second location in the first DIMM device, mark at least one DIMM boundary in the first DIMM device, generate a page fault when at least one of the operating system memory or the application memory crosses the DIMM boundary; and in response to the page fault, activate at least a second DIMM in the plurality of DIMMs in the electronic device.

### BACKGROUND

Advanced Control and Power Interface (ACPI) is a specification that makes hardware status information available to an operating system in computers, including laptops, desktop, servers, etc. More information about ACPI may be found in the Advanced Configuration and Power Interface Specification, Revision 2.0a, Mar. 31, 2002, cooperatively defined by Compaq Computer Corporation, Intel Corporation, Microsoft Corporation, Phoenix Technologies Ltd., and Toshiba Corporation. The ACPI specification was developed to establish industry common interfaces enabling robust operating system (OS)-directed motherboard device configuration and power management of both devices and entire systems. ACPI is the key element in operating system-directed configuration and power management (OSPM).

ACPI is used in personal computers (PCs) running a variety of operating systems, such as Windows® available from Microsoft Corporation, Linux, available as open source form a variety of vendors, and HP-UX, available from Hewlett-Packard Company. ACPI also allows hardware resources to be manipulated. For example, ACPI assists in power management by allowing a computer system's peripherals to be powered on and off for improved power management. ACPI also allows the computer system to be turned on and off by external devices. For example, the touch of a mouse or the press of a key may wake up the computer system using ACPI.

Among other things, ACPI implements low-power usage modes referred to as sleep states. One advantage of sleep states is that some system context information remains stored in memory during the sleep state, which reduces the time required to restore the computing system to an operational state. When a platform is in an ACPI S3 state, platform state information has been saved in the system dynamic random access memory (DRAM) and most platform components are powered down. In this state, DRAM power and the associated voltage regulator (VR) consume 50-70% of platform power. Techniques to reduce power consumption would find utility.

### BRIEF DESCRIPTION OF THE DRAWINGS

The detailed description is described with reference to the accompanying figures.

FIG. 1 is a schematic illustration of an electronic device adapted to implement dynamic power management of DIMMs according to some embodiments.

FIGS. 2-3 are flowcharts illustrating operations in a method to implement dynamic power management of DIMMs, according to some embodiments.

FIGS. 4-5 are schematic illustrations of DIMMs, according to some embodiments.

### DETAILED DESCRIPTION

Described herein are exemplary systems and methods for implementing dynamic power management of dual in-line memory modules (DIMMs) in an electronic device such as, e.g., a computer system. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

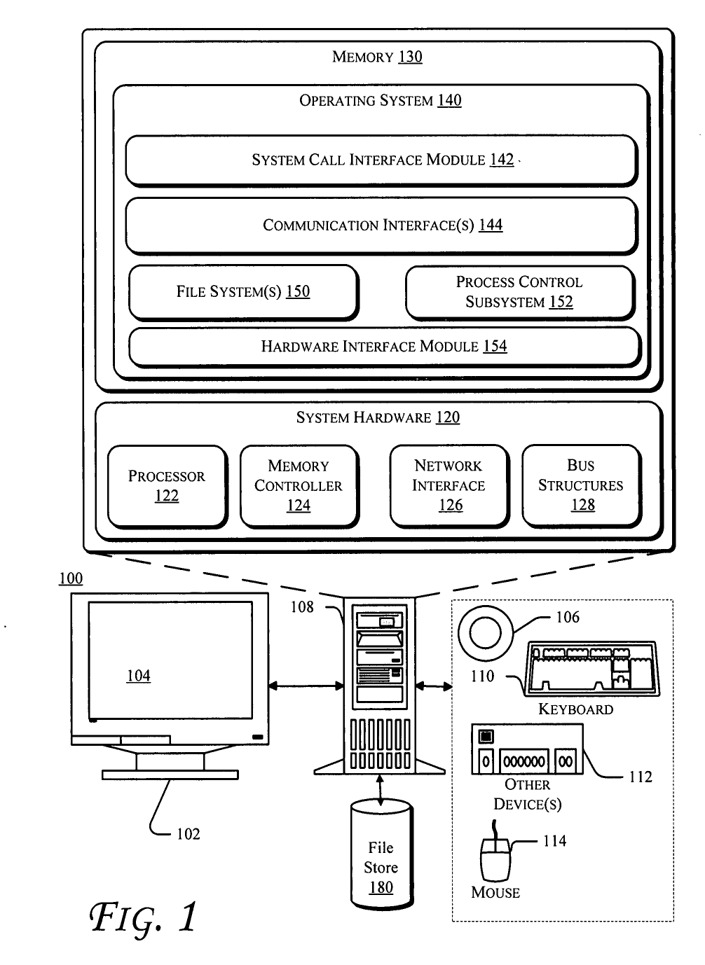

FIG. 1 is a schematic illustration of an electronic device adapted to implement dynamic power management of DIMMs according to some embodiments. In some embodiments, system 100 includes a computing device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

The computing device 108 includes system hardware 120 and memory 130, which may be implemented as random access memory and/or read-only memory. In some embodiments, at least some of the memory is implemented as dynamic random access memory (DRAM). A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, video controllers 124, network interfaces 126, and bus structures 128. In one embodiment, processor 122 may be embodied as an Intel® Pentium IV® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Memory controller 124 may function as an adjunction processor that manages memory operations. Memory controller 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

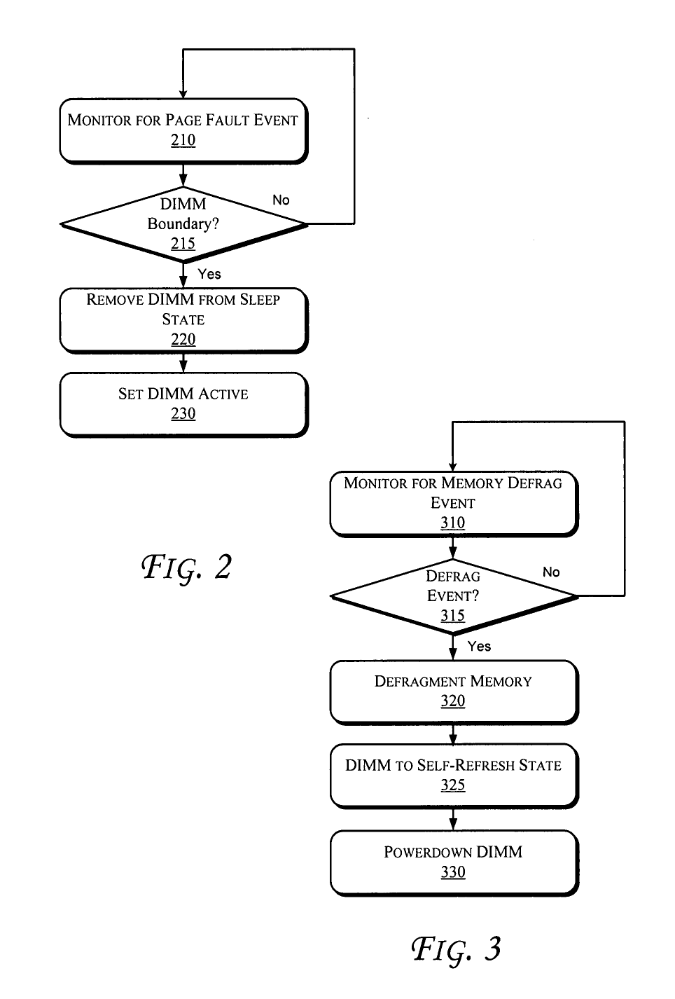

FIGS. 2-3 are flowcharts illustrating operations in a method to implement dynamic power management of DIMMs, according to some embodiments. In some embodiments, the operations illustrated in FIGS. 2-3 may be implemented by a process executing on an operating system, such as the operating system 140 depicted in FIG. 1, alone or in combination with a memory controller, such as the memory controller 124 depicted in FIG. 1.

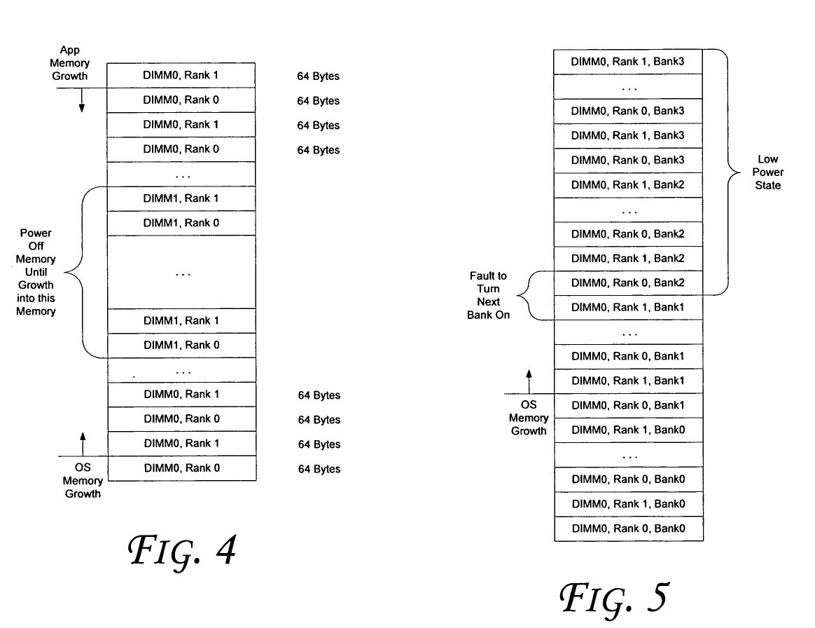

In some embodiments, prior to initiating the operations depicted in FIG. 2, for example after system boot, a first DIMM is activated, and the remaining DIMMs are placed in a sleep mode such as, for example, Self-Refresh mode, or they are completely powered down. Memory in the first DIMM is split into both high and low physical memory, and operating system memory is assigned to grow from low physical addresses to higher physical addresses, while application memory is assigned to grow from high physical addresses to lower physical addresses (see FIG. 4). In some embodiments, the operating system marks the boundaries of physical DIMMs in the page tables maintained by the operating system. Alternatively, the DRAM Controller may keep track of memory accesses and of whether these are crossing DIMM boundaries.

Referring to FIG. 2, at operation 210 in operation the operating system or the DRAM Controller monitors memory consumption to determine when a page fault event occurs, for example when a physical DIMM boundary is reached (operation 215). When a DIMM boundary is reached, one or more inactive DIMM modules are taken out of a sleep state (operation 220). At operation 230 the DIMM is placed into an active state and gets initialized. Thus, DIMM modules are activated only as the memory provided by the DIMM modules is required, thereby enabling DIMMs to remain in a sleep state until the memory provided by the DIMMs is required.

In some embodiments, the operating system implement operations to “defragment” memory occasionally (e.g., based on time) to fit it back into the single DIMM and then to power down the inactive DIMM of memory. Referring to FIG. 3, in some embodiments the rating system monitors (operation 310) for a defragmentation event. For example a defragmentation event may be scheduled periodically, or be implemented by performance criteria or memory consumption criteria. For example, a defragmentation event may be triggered when memory consumption exceeds a threshold.

When a defragmentation event is detected (operation 315), control passes to operation 320 and the memory is defragmented, for example by moving the contents of the memory into a single DIMM. At operation 325, the DIMMs which have had their memory cleared by the defragmentation operation are placed into a sleep state such as, for example, a self refresh sleep state. In some embodiments, at operation 330 one or more DIMMs which have been placed in a self refresh sleep state may be powered down to an inactive state in which memory is not refreshed.

Thus, the structure and operations depicted herein enable an electronic device such as, for example, a computer system, to utilize as few DIMMs as necessary to support memory requirements, while remaining DIMMs are maintained in a sleep mode or even powered down, thereby reducing power consumption.

The same technique can be applied not only to memory DIMMs but also to lower-level memory structures, such as ranks or banks. FIG. 3 is a schematic illustration of a DIMM that shows how this technique is implemented on the banks contained inside a single memory DIMM. The lower two banks are initially powered up and used, whereas the higher two banks are placed in a low power mode (i.e., “leaking” state, where the banks are not Self Refreshed). As operating system memory grows from the lower two banks in to the upper banks, a page fault occurs which wakes up or activates the upper two banks as well. The same defragmentation scheme we described earlier for memory DIMMs can apply on memory banks as well, potentially leading to some banks being placed back in to a low power (“leaking”) state, thereby reducing memory power dissipation.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage volatile memory comprising a plurality of dual in-line memory modules (DIMMs) in an electronic device, comprising:
activating a first DIMM while placing at least a second DIMM in a sleep mode;
assigning operating system memory to grow from a first location in a first DIMM device;
assigning application memory to grow from a second location in the first DIMM device;
marking at least one DIMM boundary in the first DIMM device;
generating a page fault when at least one of the operating system memory or the application memory crosses the DIMM boundary; and
in response to the page fault, activating at least a second DIMM in the plurality of DIMMs in the electronic device.

2. The method of claim 1, further comprising splitting memory addressing of the first DIMM into a high memory region and a low memory region.

3. The method of claim 1, wherein placing at least a second DIMM in a sleep mode comprises place the at least a second DIMM in an S3 sleep mode.

4. The method of claim 1, wherein assigning operating system memory to grow from a first location in a first DIMM device comprises assigning operating system memory to grow from low physical memory to high physical memory.

5. The method of claim 1, wherein assigning application memory to grow from a second location in the first DIMM device comprises assigning application memory to grow from high physical memory to low physical memory.

6. The method of claim 1, further comprising implementing a defragmentation operation to defragment physical memory.

7. The method of claim 6, further comprising:
completing the defragmentation operation; and
putting at least one DIMM into a sleep state.

8. An electronic apparatus, comprising:
at least one non-volatile memory module;
logic to:
activate a first DIMM while placing at least a second DIMM in a sleep mode;
assign operating system memory to grow from a first location in a first DIMM device;
assign application memory to grow from a second location in the first DIMM device;
mark at least one DIMM boundary in the first DIMM device;
generate a page fault when at least one of the operating system memory or the application memory crosses the DIMM boundary; and
in response to the page fault, activate at least a second DIMM in the plurality of DIMMs in the electronic device.

9. The electronic apparatus of claim 8, further comprising logic to split memory addressing of the first DIMM into a high memory region and a low memory region.

10. The electronic apparatus of claim 8, further comprising logic to place the at least a second DIMM in an S3 sleep mode.

11. The electronic apparatus of claim 8, further comprising logic to assign operating system memory to grow from low physical memory to high physical memory.

12. The electronic apparatus of claim 8, further comprising logic to assign application memory to grow from high physical memory to low physical memory.

13. The electronic apparatus of claim 8, further comprising logic to implement a defragmentation operation to defragment physical memory.

14. The electronic apparatus of claim 8, further comprising logic to:
complete the defragmentation operation; and
put at least one DIMM into a sleep state

15. The apparatus of claim 8, further comprising a processor, and wherein the processor comprises the logic.
